(19) United States
(12) Patent Application Publication
(10) Pub. No.: US 2006/0041479 A1
(43) Pub. Date: Feb. 23, 2006

(54) Method of distributing advertising

(76) Inventors: Robert Nesky, Hudsonville, MI (US); Brian Rosema, Fennville, MI (US)

Correspondence Address: Miller, Canfield, Paddock and Stone P.L.C.;c/o Robert Kelley Roth, Suite 2500, 150 West Jefferson Ave, Detroit, MI, 48226, US

(21) Appl. No.: 11/208,076

(22) Filed: Aug. 19, 2005

Related U.S. Application Data
(60) Provisional application No. 60/602,794, filed on Aug. 19, 2004.

(51) Int. Cl. G06Q 30/00

(52) U.S. Cl. 705/14

(57) ABSTRACT

A method of distributing advertising is disclosed, comprising the steps of securing advertising from at least one advertiser and paying a distributor to distribute the advertising at a time of purchase of items by a consumer from a distributor.

### RELATED APPLICATION

This application claims priority benefit of U.S. provisional patent application No. 60/602,794 filed on Aug. 19, 2004.

### FIELD OF THE INVENTION

This invention relates to improved methods of selling and distributing advertising, and more particularly to selling and distributing advertising for consumers in the form of coupons and coupon booklets.

### BACKGROUND OF THE INVENTION

Advertising in the form of coupons date back at least a century ago to the use of penny tokens redeemable on breakfast cereal. Today, coupons are a common promotional and marketing tool used by consumer-focused companies to stimulate purchases. Coupons take many forms: periodical insert coupons are commonly used where national and local coupons are delivered to consumers wrapped in a supermarket retailer's weekly flyer, or sent by direct mail and multi-page inserts distributed through Sunday newspapers, or in magazines, other periodicals, or posted on a website and accessible via the internet. However, the large number of coupons distributed provides only a partial indication of the level of success; also important is the frequency with which the distributed coupons are actually redeemed by the intended consumers. By its nature periodical inserts are passive and remote in time from a purchase by a consumer. Such passive advertising distribution techniques have seen a decline in coupon redemption rates. This has led advertisers to explore alternative methods of distributing advertising to improve cost efficiency and effectiveness.

Packaging coupons are another type of advertising. Packaging coupons can be incorporated either on or attached to the package of a product, inside the package of a product, or adjacent the package of a product in the form of a shelf coupon, for example. These methods of advertising distribution can also be considered to include checkout coupons, where coupons are issued at a supermarket or drug/mass merchandiser outlet checkout based upon competitive, complimentary, or like product scanned. However, advertising in the form of checkout coupons has been found to be only partially effective, and has not seen widespread adoption outside of supermarkets. Further, checkout coupons may undesirably be generated in response to private information about the consumer, including some elements of his purchasing habits.

The dry cleaning and uniform rental industries are comprised of regional, national, and locally owned companies which heretofore have seen only limited advertising. Location and value added services are desirable for these mature industries. Uniform rental and industrial laundering businesses have recently started adding items such as dust control rugs, monogrammed items, employee appreciation items, paper & sanitary supply items, etc. along with the regular shirts and pants. Most deliver on a weekly basis and have long-term contracts in place to assure customer retention. Dry cleaners have operated virtually unchanged for decades, relying heavily on location and advertising. It is estimated that there are approximately 20,000,000 uniformed employees in the United States, with 3,500 Uniform rental companies and 11,000 dry cleaners with 115,000 locations. The combined industries in 2002 created $11 billion in annual revenues. The average uniform rental company delivers about 10,000 uniforms per week. The average dry cleaners have roughly 400-500 customer orders per week. Thus there is a large potential market for advertising. It would be highly desirable to have an improved method of distributing advertising in relatively untapped markets which could provide higher redemption rates and which would enhance revenue for advertisers.

### SUMMARY OF THE INVENTION

In accordance with a first aspect, a method of distributing advertising by a marketer to a consumer through a distributor comprises the steps of securing advertising from at least one advertiser, and paying a distributor to distribute the advertising at a time of purchase of items by a consumer from a distributor.

From the foregoing disclosure and the following more detailed description of various preferred embodiments it will be apparent to those skilled in the art that the present invention provides a significant advance in the technology and art of method of distributing advertising. Particularly significant in this regard is the potential the invention affords for providing a new way of penetrating an existing market, increasing customer use of advertising at the advertiser's places of business. Additional features and advantages of various preferred embodiments will be better understood in view of the detailed description provided below.

### BRIEF DESCRIPTION OF THE DRAWINGS

FIG. 1 is a flow chart of a method of distributing advertising in the form of coupons and similar offers.

FIG. 2 is an example of a booklet of coupons distributed according to a preferred embodiment where the booklet is attached to a hanger which hangs clothes as would be used by a dry cleaning company, a uniform rental company, etc.

FIG. 3 is another example of a booklet of coupons distributed according to a preferred embodiment where the booklet is attached to a twist tie as would be used by a dry cleaning company, a uniform rental company, etc.

It should be understood that the appended drawings are not necessarily to scale, presenting a somewhat simplified representation of various preferred features illustrative of the basic principles of the invention. The specific design features of the method of distributing advertising as disclosed here will be determined in part by the particular intended application and use environment. Certain features of the illustrated embodiment have been distorted relative to others to help visualization and clear understanding. All references to direction and position, unless otherwise indicated, refer to the orientation illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the method disclosed here. The following detailed discussion of various alternative and preferred features and embodiments will illustrate the general principles of the invention with reference to advertising in the form of coupons and other offers used with uniform rental companies, dry cleaners, Laundromats, etc. Other embodiments suitable for other applications, such as restaurants, will be apparent to those skilled in the art given the benefit of this disclosure.

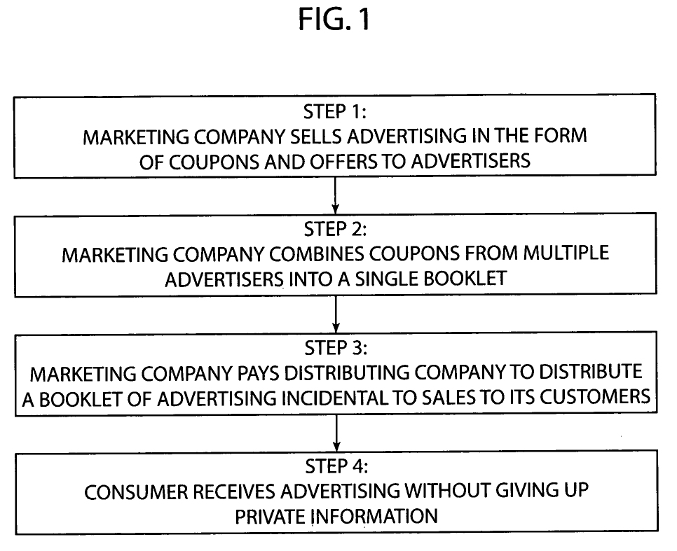

Turning now to the drawings, FIG. 1 shows a flowchart in accordance with a preferred embodiment. A marketer or marketing company sells advertising in the form of coupons and offers to advertisers. Generally, the advertisers may be manufacturers of goods or providers of services or retailers. The advertisements can be from local or national business entities that need or want to advertise their products or services to consumers and/or customers. For example, a restaurant (either a national chain or a local eatery) may advertise with a coupon offering a buy one sandwich, get one free. Preferably the advertisers are geographically proximate to a distributor, i.e., the advertisers place of business is sufficiently close to the entity that distributes the advertisements that the consumer can travel to the advertiser easily during the course of a day. Most preferably the advertiser is within 5-10 miles of the distributor.

Once the advertising is secured from the advertisers, it may be combined with advertisements from other advertisers in the form of a booklet. Also, instead of a booklet, the advertising may take the format of a flyer, a poster, a hangtab or one or any other printed medium or combination of mediums. The booklet may optionally be provided with a unique color indicating the type of coupon a customer could expect to see and establishing how the booklet will be viewed in the marketplace. After printing, the booklets may be shipped to the distributors. Distributors can comprise several different kinds of companies. Most preferably a distributor can be one of uniform rental companies, dry cleaners, Laundromats, and restaurants. Many of these businesses have used advertising in the promotion of their own companies but not as a way to delivering advertising to their customers. Other rental companies, including equipment rental companies, may act as a distributor.

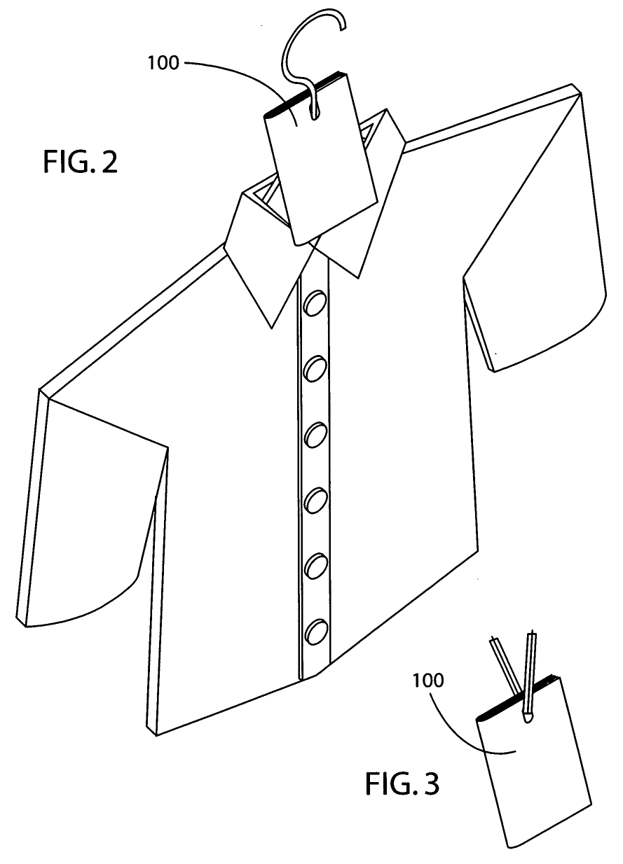

FIGS. 2 and 3 show a pair of preferred embodiments where the items to be sold are articles of clothing, as may typically be the case for uniform rental companies, dry cleaners, Laundromats, etc. The advertising is formed as a booklet 100 with, for example, 6-8 coupons attached. These coupons are from businesses that consumers use on a regular basis. The booklet 100 may simply be included with the dry-cleaning order attached to a hangar as shown in FIG. 2, attached to a twist tie as shown in FIG. 3, or otherwise delivered along with a weekly uniform rental order.

In accordance with a highly advantageous feature, at Step 3 the marketing company pays the distributing company to distribute the booklet of advertising with the items it sells to its customers. For example, the coupon booklets can be attached or delivered with the uniform rental order, dry-cleaning order, or in the case of a restaurant, at the time of billing. Importantly, the advertising is distributed to the customer at the time of purchase of the items the distributor would regularly sell to its consumers. Time of purchase is understood here to also mean time of rental, as would be the case with rental companies. The coupons distributed may be incidental to the items purchased. That is, the coupons may not be for the distributor, but rather, may be for an advertiser that is geographically proximate to the distributor. Paying the distributor advantageously enlists the aid of the distributor, helping to ensure the distribution of advertisements.

In Step 4, the consumer/customer takes delivery of his items, and his advertising as well. Advantageously, the advertisements have a 100% delivery rate to a group of customers targeted by the advertisers without privacy issues. That is, the consumer is now in receipt of the coupon booklet and is free to use them at the businesses that have paid for the advertising. The consumer has given up no private information in order to get these offers. With other forms of advertising (print, direct mail, phone, internet), the advertiser may obtain private information (address, phone number, email address, consumer habit, etc.) in order to deliver its advertising.

Advantageously, presentation of advertising, advertising costs, commission structure, booklet layout, agreements, and order information may be available to advertisers through a web-site or via secured email. Potential advertisers and distributors can have an information packet available with full information describing how to engage the marketing company for distributing advertising according the present invention. Interactions with a printing supplier are also preferably internet based.

The method disclosed herein has numerous advantages over known methods of distributing advertising. For example, distributors, particularly uniform rental companies, dry cleaners, Laundromats and restaurants, etc., are provided a new way to add value for their customers, differentiate themselves from their competitors, and provide an additional revenue stream. Customer satisfaction is enhanced along with customer retention and loyalty. Further, advertisers have a new way to target consumers, not just geographically but also demographically. For example, the average customer of a dry cleaner has a higher household income than the average consumer in the same market. Thus, instead of spending valuable monies on other marketing methods that blanket an entire geographic area, use of Applicant's invention allows the advertiser to effectively target a more valuable demographic segment of customers. Moreover, the customer/consumer receives these targeted offers without loss of privacy. The advertising is delivered to the customer independent of the advertiser or the marketing company having knowledge of his private information.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method of distributing advertising by a marketer to a consumer through a distributor comprising, in combination, the steps of:
securing advertising from at least one advertiser;
paying a distributor to distribute the advertising at a time of purchase of items by a consumer from a distributor.

2. The method of claim 1 further comprising combining the advertising of multiple advertisers into a booklet.

3. The method of claim 1 wherein the distributor is one of rental companies, dry cleaners, and restaurants, each of which sells its respective item to the consumer.

4. The method of claim 3 wherein the item sold to the consumer is an article of clothing mounted on a hanger, and the advertising is attached to the hanger.

5. The method of claim 1 wherein the advertiser is one of a manufacturer of items, a provider of services, and a retailer.

6. The method of claim 1 wherein the consumer has private information, and the booklet is distributed to the consumer independent of knowledge of the private information by the distributor.

7. The method of claim 6 wherein the private information of the consumer comprises one of an address, a phone number, an e-mail address, and a consumer habit.

8. The method of claim 7 wherein the consumer habit comprises a pattern of purchases.

9. The method of claim 1 wherein the advertisers are geographically proximate to the distributor.

10. The method of claim 1 wherein the advertiser is the same as the distributor.

11. The method of claim 1 wherein the items purchased are unrelated to items which are advertised.
